(19) United States
(12) Patent Application Publication
(10) Pub. No.: US 2026/0287147 A1
(43) Pub. Date: Sep. 24, 2026

(54) LIGHTING DEVICE

(71) Applicant: SIGNIFY HOLDING B.V., EINDHOVEN (NL)

(72) Inventors: ERIK PAUL BOONEKAMP, BUNNIK (NL); MICHEL CORNELIS JOSEPHUS MARIE VISSENBERG, ROERMOND (NL)

(21) Appl. No.: 19/167,882

(22) PCT Filed: Mar. 19, 2024
(86) PCT No.: PCT/EP2024/057304

§ 371 Date: Sep. 23, 2025

(30) Foreign Application Priority Data
Mar. 23, 2023 (EP) 23163753.9

(51) Int. Cl. F21V 7/00; F21S 8/04; F21V 3/06; F21V 7/04; F21V 9/40; F21Y 115/10

(52) U.S. Cl. CPC F21V 7/0016; F21S 8/04; F21V 3/0615; F21V 7/048; F21V 9/40; F21Y 2115/10

(57) ABSTRACT

A lighting device (100) comprising: a light source (102) configured to emit light from a light emitting area (102a) of the light source (102), towards a light exit window (104) of the lighting device (100), along an optical axis (L); and a transflective wall structure (106) for reducing a glare of the light emitting area (102a) when viewed through the wall structure (106), the wall structure (106) surrounding the light emitting area (102a) and extending between the light emitting area (102a) and the light exit window (104) in a direction substantially parallel to the optical axis (L), wherein the light emitted from the light emitting area (102a) comprises a direct portion propagating directly between the light emitting area (102a) and the light exit window (104), and a divergent portion incident on an inwardly facing surface (106′) of the wall structure (106), and wherein the transflective wall structure (106) is transparent and specularly reflective such that the divergent portion of the light is in part transmitted through the wall structure (106), and in part guided towards the light exit window (104) by being specularly reflected by the wall structure (106).

### FIELD OF THE INVENTION

The present invention generally relates to a lighting device.

### BACKGROUND OF THE INVENTION

Glare is a notable quality aspect of all lighting systems. Therefore, it is typically an aim to reduce glare to an acceptable level. Glare reduction is traditionally connected to changes in light distribution by using elements such as lamellae, reflectors, or prism sheets, to reduce the luminance at large viewing angles relative the optical axis of the light source (e.g., viewing angles exceeding 60 degrees for indoor lighting and angles exceeding 75 degrees for outdoor lighting), thereby increasing visual comfort. However, in some applications (indoor as well as outdoor applications), it may be desirable to reduce glare without altering the initial intensity profile of the light emitted by the light source, for instance because either the intensity distribution is fixed by the illumination targets, or a further glare reduction is needed. One approach for achieving this is to increase the light emitting area of the light source, which, at the same luminous intensity, will automatically lead to a lower luminance. However, an increased area is associated with drawbacks, such as a negative impact on cost and environment due to the increased use of materials (optics, fixture, housing, etc.) and larger volume and weight during transport and installation.

WO2013057644A1 discloses a split beam luminaire and lighting system having transflective outer side walls.

### SUMMARY OF THE INVENTION

It is an object of the present invention to provide a lighting device which enables glare reduction while avoiding or mitigating one or more of the above-described drawbacks. More specifically, it is an object to enable a reduced glare without physically increasing the light emitting area of the light source. These and other objects may be achieved by a lighting device in accordance with the independent claim. Embodiments of the present invention are defined in the dependent claims.

Hence, according to an aspect of the present invention, there is provided a lighting device comprising:
a light source configured to emit light from a light emitting area of the light source, towards a light exit window of the lighting device, along an optical axis; and
a transflective wall structure for reducing a glare of the light emitting area when viewed through the wall structure, the wall structure surrounding the light emitting area and extending between the light emitting area and the light exit window in a direction substantially parallel to the optical axis,
wherein the light emitted from the light emitting area comprises a direct portion propagating directly between the light emitting area and the light exit window, and a divergent portion incident on an inwardly facing surface of the wall structure, and
wherein the transflective wall structure is transparent and specularly reflective such that the divergent portion of the light is in part transmitted through the wall structure, and in part guided towards the light exit window by being specularly reflected by the wall structure.

Thus, the present invention is based on the idea of reducing glare by providing a virtual increase of the light emitting area of the light source. That is, when viewing the light emitting area of the light source (which hereinafter may also be referred to as source area, or (diffusive) light emitting area, or (diffusive) light emitting surface) through the transflective wall structure (e.g. a sidewall portion thereof), the divergent portion of the emitted light will be intercepted by the transflective wall structure and the source area will thus be shielded thereby. The average luminance of the source area as viewed through the transflective wall structure will thus be reduced. Meanwhile, the reflected parts of the divergent portion of the light will appear to originate from virtual source areas adjacent the original source area, having a lower luminance than the original luminance of the physical source area. In this way, a larger combined virtual source area with a substantially preserved intensity and a lower luminance and lower glare level may be created. Owing to the specular reflectivity of the inwardly facing surface of the wall structure, light may undergo multiple specular reflections between inwardly facing surface portions before being transmitted through the wall structure or through the light exit window.

For benefiting more from an effective glare reduction, the wall structure should typically be arranged as close to the periphery of the source area as possible. A separation or gap between the wall structure and the source area preferably is absent, i.e. the light emitting area touches the transflective walls such that the source and the virtual source are connected. Such a gap creates a “dark” transition zone which may create an unwanted contrast between the source area and the virtual source surface. As may be appreciated, the size of the separation/gap at which this may become noticeable generally depends on a viewing distance.

By the term “transflective” is hereby meant that the wall structure (e.g. any given sidewall portion thereof) is semi-transparent, i.e. both transparent and (specularly) reflecting, such that light incident on an inwardly facing surface of any given portion of the wall structure is in part specularly reflected and in part transmitted through the portion. In the following, any reference to “reflection”, “reflectance”, or the like is to be understood to refer to a “specular” reflection or reflectance, unless stated otherwise.

By the term “transparent” is hereby meant that the transmission of light is non-scattering, in other words allowing light to pass through the wall structure without any appreciable scattering.

Typically, the wall structure connects the light emitting area with the light exit window, in that it extends from the light emitting area onto the light exit window.

According to an embodiment, the wall structure has a specular reflectance in a range from 14% to 86%, preferably 20% to 80%, or even more preferably 40% to 60%, for the light emitted by the light source. A spectral reflectance in these ranges has proven to allow an increasingly efficient glare reduction. In general, the reflectance should be sufficiently high to make the virtual source areas bright enough to be considered as part of the original source area. On the other hand it should be low enough such that the original source is still bright enough. In particular, the stated reflectance ranges may be ranges of an average specular reflectance of the wall structure, averaged over a range of angles of incidence.

According to an embodiment, the wall structure comprises first and second sidewall portions arranged on opposite sides of, and at a same distance from, the optical axis. This arrangement of mutually opposite sidewall portions allows incident light from the light source to be specularly reflected multiple times between the sidewall portions before being transmitted either through the wall structure or through the light exit window. Arranging the first and second sidewall portions at a same distance from the optical axis L enables providing a glare reduction of a same strength when viewing the light emitting area through either the first or second sidewall portions.

According to an embodiment, the light source is configured to emit the light in a luminous intensity distribution having at least a first plane of symmetry, and wherein the first and second sidewall portions are flat sidewall portions substantially parallel to the first plane of symmetry and arranged on opposite sides of, and at a same distance from, the first plane of symmetry. Thereby, the plane of symmetry of the luminous intensity distribution provided by the physical source area may be preserved by the luminous intensity distribution provided by the virtual source area. The symmetric placement of the first and second sidewall portions with respect to plane of symmetry enables that reflections at one sidewall portion, in a direction towards the other sidewall portion, are counteracted by reflections at the other sidewall portion, in the opposite direction, such that the overall intensity distribution does not change.

According to an embodiment, the wall structure comprises third and fourth sidewall portions connecting the first and second sidewall portions and arranged on opposite sides of the optical axis. Thereby, the transflective wall structure may form a hollow box, completely surrounding the source area and the optical axis in a circumferential direction.

According to an embodiment, the luminous intensity distribution further has at least one second plane of symmetry transverse to the first plane of symmetry, and wherein the third and fourth sidewall portions are flat sidewall portions being substantially parallel to the second plane of symmetry and arranged on opposite sides of, and at a same distance from, the second plane of symmetry. Thereby, two transverse planes of symmetry of the luminous intensity distribution (i.e. a beam with quadrant symmetry) provided by the physical source may be preserved by the luminous intensity distribution provided by the virtual source area.

According to an embodiment, the light source is configured to emit the light in a luminous intensity distribution being radially symmetric with respect to the optical axis, and wherein the wall structure is radially symmetric with respect to the optical axis, or wherein the wall structure comprises first, second, third and fourth flat sidewall portions arranged in a shape of a rectangle or square centered on the optical axis. Thereby, a virtual source area providing a luminous intensity distribution preserving the radial symmetry of the luminous intensity distribution (i.e. a beam with rotational symmetry around the optical axis) provided by the physical source area may be achieved. The symmetry may be preserved using a wall structure with either a circular cylindrical shape or rectangular or square shape (e.g. a rectangular- or square-shaped hollow box) centered on, i.e. having a center coinciding with, the optical axis/symmetry axis. A square or rectangular shape corresponds to an n-sided polygon wherein n=4. More generally, the wall structure may comprise a number n of sidewall portions arranged in a shape of an n-sided polygon centered on the optical axis, wherein n is an even number equal to or greater than 4 (e.g. n=6, 8, 10, . . . ). Such shapes of the wall structure also allows the radial symmetry of the luminous intensity distribution to be preserved since reflections at any one of the n sidewall portions of the n-sided polygon, in a direction towards a directly opposite sidewall portion with respect to the optical/symmetry axis, are counteracted by reflections at this other sidewall portion, in the opposite direction, such that the overall intensity distribution does not change.

According to an embodiment, the wall structure extends along at least a part of a periphery of the light emitting area. The wall structure may in particular extend along a full length of the periphery of the light emitting area. Glare reduction may thus be provided for any azimuthal viewing angle (wherein “azimuthal” denotes the viewing angle within a plane transverse to the optical axis).

According to an embodiment, the light emitting area is a diffusive, flat, light emitting surface extending in a plane transverse to the optical axis and the wall structure. The light source may for example comprise one or more light emitting devices, such as one or more LEDs, and the diffusive light emitting surface (or (diffusive) light emitting area), the light source being configured to transmit light through the light emitting area. Typically the LEDs are arranged as bright light emitting pixels in a two-dimensional array, which due to their high brightness likely cause glare. The diffusive, light emitting area of said array of LEDs spreads the light from the LEDs to render the lighting device to have a diffuse light emitting, non-pixelated light source exhibiting a light emitting surface of relatively uniform luminance and to render the lighting device to emit a diffuse beam of light. Thus, both real views of the light source and virtual images of the light source appear diffuse, and thus glare is reduced.

According to an embodiment, the light emitting surface is a Lambertian emitter rendering the lighting device to emit light with a Lambertian intensity distribution. Thus, an even more even luminous intensity distribution may thereby be provided by the physical source area, with a same symmetry as the shape of the light emitting surface.

The diffusive, light emitting surface involves the effect that the luminance at large angles, i.e. at angle α of at least 65 degrees (also known as L65), with a normal to the diffusive, light emitting area/surface is relatively high. To benefit even more from the advantageous effect of the invention, it is preferred, in operation, that the luminance at angles α>=65 degrees is at least 500 cd/m², both for the reflected light as for the light transmitted by the transflective walls. This means that for a reflection, R, of 50% and a transmission, T, of 50% of the transflective walls the luminance of the LED should be at least 1000 cd/m² at α=65 degrees. For other ratio's between R and T of the transflective walls, for example, for R=20% and T=80% then L65>=2500 cd/m², and for R=14% and T=86% then L65>=3600 cd/m². The criterium L65>=1000 cd/m² with R=T=50% and 60*60 cm panels, is met by Lambertian panels emitting >1 klm (kilolumen), by Slimblend panels emitting >2 klm, and PowerBalance or MLO type panels emitting >4 klm.

According to an embodiment, a separation between the wall structure and a periphery of the light emitting area is at most 100 mm, or at most 50 mm, or at most 20 mm. A separation in these respective ranges may limit luminance contrasts in the virtual source images for mounting heights of the lighting device typical for large street or road lighting applications, industrial or urban outdoor lighting applications, and indoor lighting applications, respectively. A too great luminance contrast may otherwise reduce the effectiveness of the glare suppression. The distance between a viewer and the light source tends to be greater in industrial and outdoor lighting applications than in indoor lighting applications, and thus a greater separation is acceptable. For home indoor lighting applications, an even smaller separation of at most 10 mm may be advantageous, i.e. the wall structure may be arranged with essentially zero separation from the periphery of the light emitting area.

According to an embodiment, a height of the wall structure, with respect to the light emitting area, is such that the (entire) light emitting area is shielded by the wall structure when viewed from a viewing angle relative the optical axis exceeding a threshold angle, wherein the threshold angle is in a range from 40-70°. Glare suppression may thus be provided for viewing angles suitable for many typical lighting applications.

According to an embodiment, a height of the wall structure, with respect to the light emitting area, varies along a circumferential direction with respect to the optical axis (e.g. along the periphery of the light emitting area). The angle with respect to the optical axis at which the source area is fully shielded by the wall structure may hence be varied along the circumference of the wall structure, i.e. along the azimuthal viewing direction. This may be useful for elongated source areas, such as non-square rectangular shaped source areas, wherein, for instance, a height of the wall structure (which as set out above may comprise first through fourth flat sidewall portions arranged in a rectangular shape) may be greater at corner portions of the wall structure than at central portions of the sidewall portions along the source area.

According to an embodiment, the wall structure has an (average) specular reflectance which varies along the optical axis. For example, the reflectance may gradually and/or continuously decrease from the light source to the light exit window (or vice versa) in the direction along the optical axis. The amount of light transmitted through the wall structure may thus be tuned along the optical axis, for instance to obtain a more uniform luminance.

According to an embodiment, the exit window is an aperture or a transparent window. In other words, the wall structure may extend to and surround a light exit aperture (i.e. an open side) of the lighting device, or a transparent window.

### BRIEF DESCRIPTION OF THE DRAWINGS

This and other aspects of the present invention will now be described in more detail, with reference to the appended drawings showing embodiments of the present invention.

FIG. 1 schematically shows a perspective view of a lighting device according to an exemplifying embodiment of the present invention.

FIG. 2 shows a side view of the lighting device of FIG. 1.

FIGS. 3a-d and 4a-d show luminance images generated using ray tracing software for a bare source area and the corresponding source area when viewed through a transflective wall structure.

FIGS. 5a-b show a lighting device without a transflective wall structure as a comparative example (FIG. 5a), and further a lighting device provided with a transflective wall structure according to an exemplifying embodiment (FIG. 5b).

### DETAILED DESCRIPTION

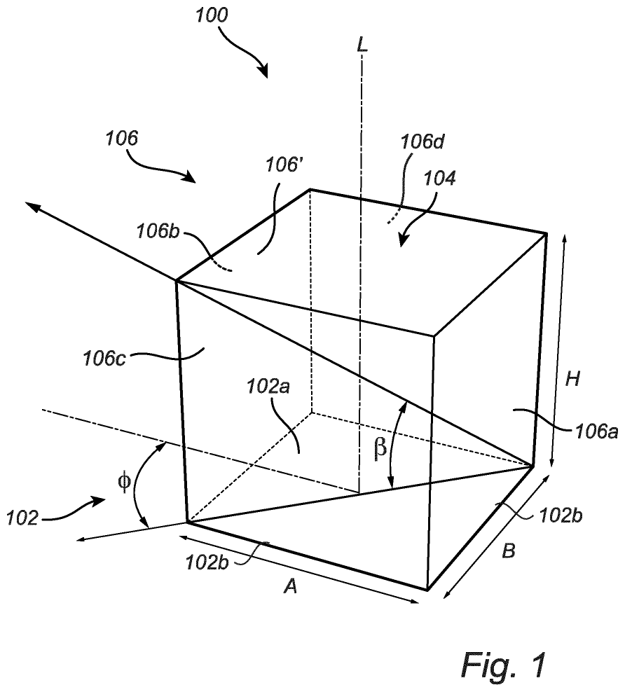

FIG. 1 schematically shows a perspective view of a lighting device 100. The lighting device 100 comprises a light source 102 and a light exit window 104. The light exit window 104 may be an open aperture or a transparent window, such as a clear glass window. The light source 102 is divergent and thus configured to emit a divergent light distribution or beam. The light source 102 is configured to emit the light from a light emitting area or source area 102a of the light source 102, in a direction along an optical axis L, towards the light exit window 104. The optical axis L as shown defines an optical axis of the lighting device 100. As will be further discussed in the below, the optical axis L may constitute an axis of symmetry of the (divergent) light distribution emitted from the light emitting area 102a.

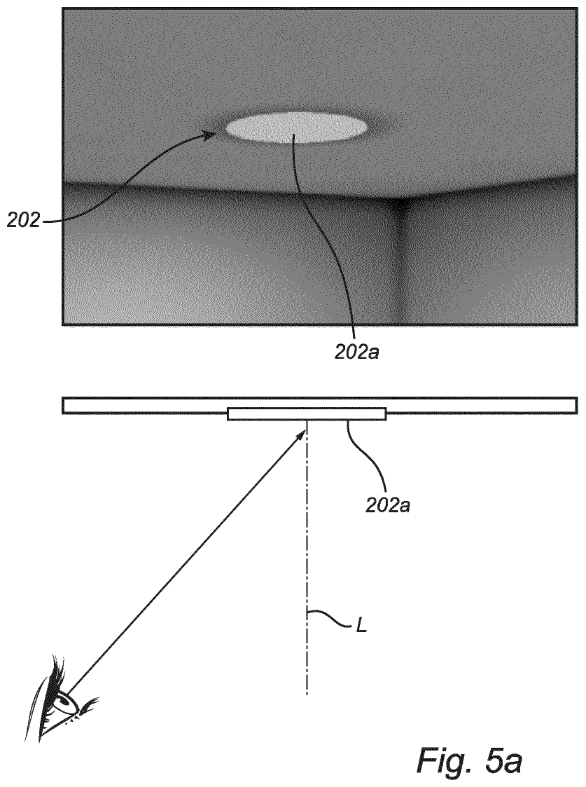

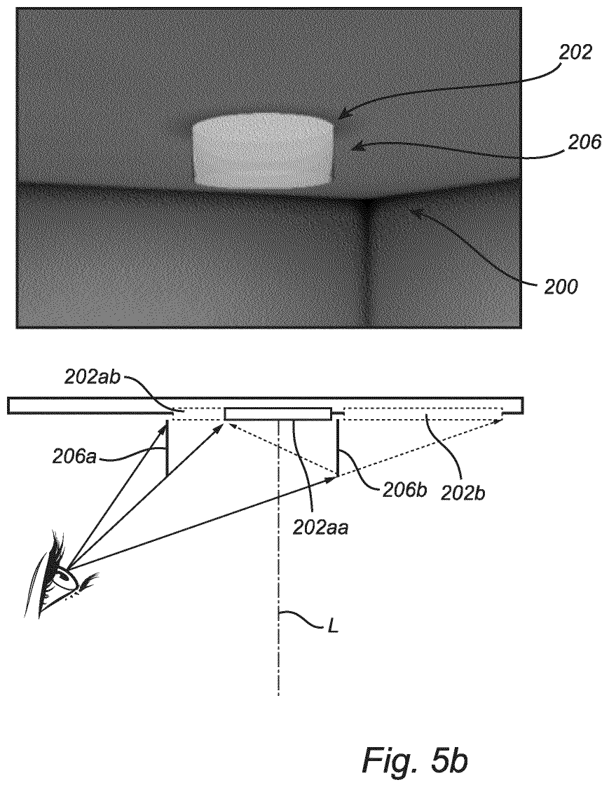

In the illustrated example, the source area 102a is a diffusive, flat light emitting surface or source surface 102a extending in a plane substantially transverse to the optical axis L. The source area 102a is further substantially parallel to a plane of extension of the light exit window 104. The light source 102 may for example comprise one or more light emitting devices, such as one or more LEDs, arranged behind the source surface 102a of the light source and configured to transmit light through the source surface 102a. The light emitting area 102a as shown may be of a rectangular shape. However, also other shapes are possible such as square, circular or rounded (e.g. oval), for example as shown in FIG. 5b.

The source surface 102a may be a Lambertian emitter. A Lambertian emitter may be realized using a translucent diffusing screen, wherein the light emitted by the light emitting device(s) of the light source 102 may be transmitted and diffusively scattered by the diffusing screen. In another example a Lambertian emitter may be realized using another diffusing optical element, such as a diffusing lens, wherein the source surface 102a may be an exit surface of the diffusing optical element. The lighting device 100 is however not limited to use with a Lambertian light source, but may more generally be used with any light source providing a divergent light distribution. For example, the light source 102 may comprise various light-shaping optics, such as lenses and/or reflectors, for shaping the light emitted by the one or more light emitting devices into a desired divergent light distribution. In this case, the light emitting area 102a may be an open aperture or a transparent window, such as a clear glass window.

Still with reference to FIG. 1, the lighting device 100 further comprises a transflective wall structure 106, “transflector” or semi-transparent reflector. The light emitted from the light emitting area 102a comprises a direct portion propagating directly between the source surface 102a and the light exit window 104, and a divergent portion incident on an inwardly facing surface (106′) of the wall structure 106. The wall structure 106 allows reducing or suppressing a glare of the light emitting area 102a produced by the divergent portion of the light, when viewed through the wall structure 106. For this purpose, the wall structure 106 surrounds without a gap the light emitting area 102a and extends towards the light exit window 104 in a direction substantially parallel to the optical axis L, and thus substantially transverse to the plane of the source surface 102a. As per the illustrated example, the wall structure 106 may more specifically extend between the light emitting area 102a and the light exit window 104, i.e. here extends from the light emitting area 102a onto the light exit window 104, and thus connects the light emitting area 102a with the light exit window 104.

More specifically, the wall structure 106 as shown comprises first, second, third and fourth flat sidewall portions 106a-d arranged in a shape of a hollow rectangular box. In the illustrated example, the “box” or wall structure 106 has an open inlet side facing the source area 102a and an open outlet side facing or defining the light exit window 104. The wall structure 106 has a first width dimension A, a second width dimension B and a height dimension H, wherein the height dimension is defined by the height of the wall structure 106 above the source area 102a, as seen along the optical axis L.

The first and second sidewall portions 106a-b are substantially parallel to each other and extend along a periphery 102b of the source surface 102a, on opposite sides of the optical axis L. In particular the first and second sidewall portions 106a-b are arranged directly opposite each other such that the respective inwardly facing surface portions of the first and second sidewall portions 106a-b face each other. The first and second sidewall portions 106a-b are connected by the third and fourth sidewall portions 106c-d extending transverse to the first and second sidewall portions 106a-b. The third and fourth sidewall portions 106c-d are substantially parallel to each other and extend along the periphery 102b of the source surface 102a, on opposite sides of the optical axis L. In particular the third and fourth sidewall portions 106c-d are arranged directly opposite each other such that the respective inwardly facing surface portions of the third and fourth sidewall portions 106a-b face each other.

The first and second sidewall portions 106a-b are arranged at a same distance from the optical axis L (e.g. A/2). Correspondingly, the third and fourth sidewall portions 106c-d are arranged at a same distance from the optical axis L (e.g. B/2). The wall structure 106 may hence be centered on, i.e. aligned with, the optical axis L.

The wall structure 106 is transflective in the sense that it is both transparent and specularly reflective. Thereby, the divergent portion of the light which is incident on or intercepted by the inwardly facing surface of the wall structure 106 is in part transmitted through the wall structure 106, and in part guided towards the light exit window 104 by being specularly reflected by the wall structure 106, e.g. by the inwardly facing surface thereof. As may be appreciated, the divergent portion of the light may be specularly reflected a number of times by the wall structure 106 before being transmitted from the light exit window 104, and hence, due to the transparency of the wall structure, gradually leak out and thus be emitted from the sidewall portions 106a-d of the wall structure 106. To a viewer viewing the source area 102a through a given sidewall portion of the wall structure 106, such as the first sidewall portion 106a, the light emitted from the first sidewall portion 106a will appear to originate from virtual source areas adjacent to the source area 102a, having a lower luminance than the luminance of the physical source area 102a, thereby creating the impression of an enlarged combined virtual source surface with a same luminous intensity (at least substantially) as the physical source surface 102a but a lower luminance and lower glare level.

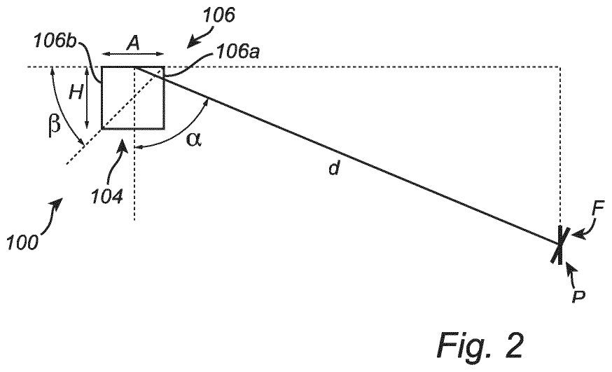

The angle β in FIG. 1 indicates the maximum angle with respect to the source surface 102a at which the wall structure 106 fully shields the source surface 102a from any azimuthal viewing direction or angle φ. As may be seen from FIG. 1, the angle β is an angle defined in a vertical plane while the azimuthal angle φ is an angle in a horizontal plane. “Vertical” and “horizontal” are here only used in a relative sense to refer to a plane transverse to the plane of the source area 102a and parallel to or coinciding with the plane of the source area 102a, respectively. The azimuthal angle φ as shown is more specifically defined with respect to a reference axis coinciding with the plane of the source area 102a and having the origin at the intersection between the optical axis L and the source area 102a. Put differently, the azimuthal angle φ is the angle between the projection of the line of sight from the center of the source area 102a and the viewer onto the plane of the source area 102a, and a reference axis in the plane of the source area 102a. As may be appreciated, the reference axis and the azimuthal angle φ may equally well be defined within any (horizontal) plane parallel to the source area 102a. At vertical viewing angles greater than the angle β, the wall structure 106 may only shield a part of the source area 102a, and hence still reduce the glare, but to a lesser extent. The term “vertical viewing angle” should here be understood as the angle between the optical axis L and the line of sight from the center of the source area 102a to the viewer (e.g. α in FIG. 2). A height H of the wall structure 106, with respect to the source area 102a, may for example be such that β is in a range from 20-50°. This is equivalent to the height of the wall structure 106 being such that the entire source area 102a is shielded by the wall structure 106 when the source area 102a is viewed from a viewing angle relative the optical axis exceeding a threshold angle αₜₕₑ, wherein αₜₕₑ is in a range from 40-70°, such as αₜₕ=60°.

The specular reflectance of the wall structure 106 may be independent of incident angle, such that the wall structure 106 may present a constant or uniform specular reflectance. The specular reflectance of the wall structure 106 may be uniform along the height dimension. However, the reflectance may also be modulated along the height dimension H, such that the reflectance of the wall structure 106 depends on the position or height along the height dimension H. Thereby, the amount of light transmitted through the wall structure 106 may be tuned along the optical axis L, for instance to obtain a more uniform luminance. In any case, the wall structure 106 may have a specular reflectance in a range from 14% to 86%, more preferably 20% to 80%, or even more preferably 40% to 60%, for the light emitted by the light source 102. These reflectance ranges enable an increasingly efficient glare reduction. Depending on the composition and materials of the wall structure 106, the reflectance may present a dependence on angle of incidence of the light. Hence, the specular reflectance may refer to the average specular reflectance of the wall structure, wherein average denotes an angular average, i.e. the specular reflectance averaged over a range of angles of incidence such as 0° to 90°. The average specular reflectance may however also be determined over a more narrow range of angles of incidence corresponding to a range of relevant vertical viewing angles in which the glare reduction is to be provided, such as an angle of incidence in a range from 0° to 50°.

The transflective wall structure 106 may be adapted to present no, or substantially no, appreciable absorption in the wavelength region of interest, e.g. the visible part of the spectrum emitted by the light source 102. In practice, for the envisaged compositions and structures of the wall structure 106 an absorption of less than 5%, or even less than 1%, may be readily achieved. Hence, the absorption A of the transflective wall structure 106 may to a good approximation be considered zero wherein the transmittance T and the specular reflectance R (e.g. average or at a given position of the wall structure 106) may be related by R=1−T.

A transflective wall structure may be realized in various different manners. The wall structure 106 may be formed of glass, quartz, or a polymer such as polycarbonate or Poly(methyl methacrylate) (PMMA), coated with a dielectric multilayer. The multilayer can be optimized to obtain the desired reflectance. The coating can be on the inwardly facing surface of the wall structure 106, or on an outwardly facing surface of the wall structure 106. The reflection may according to other examples be determined by a silver or aluminum layer (with the thickness tuned to provide the desired transmittance). According to yet another example, the wall structure 106 may be formed by a stack of thin transparent layers (such as 2-3 or more clear layers of e.g. glass, quartz or polymer films or foils) with air gaps (>1 μm) in between them. The reflectance of the wall structure 106 may in this case be tuned by the number of thin layers and the refractive index of the transparent layers. For example, with two layers of PMMA a perpendicular reflectance (a 90° incidence angle) of about 14% may be achieved, which increases to about 19% at 50° incidence angle. Three layers of PMMA provide a perpendicular reflectance of about 20%.

For an effective glare reduction, the wall structure 106 should typically be arranged as close to the periphery 102b of the source area 102a as possible. A separation or gap between the wall structure and the source area 102a creates a “dark” transition zone which may create an unwanted contrast between the source area 102a and the virtual source surface. As may be appreciated, the separation at which this may become noticeable generally depends on a viewing distance. In practice, a separation between the wall structure 106 and the periphery 102b of the light emitting area 102a of at most 100 mm may be suitable for larger street and road (e.g. highways) lighting applications, or at most 50 mm for industry lighting applications or urban and smaller street lighting applications, or at most 20 mm for indoor workplace lighting application (e.g. offices, corridors, hotels), or at most 10 mm for indoor home lighting applications, or even be essentially/practically zero.

In case the source area 102a is a Lambertian source surface, due to the rectangular shape of the illustrated source surface 102a, the light will be emitted from the source surface 102a in a luminous intensity distribution having a first plane of symmetry and a second plane of symmetry transverse to the first plane of symmetry (intersecting each other along the optical axis L). In this case, the first and second sidewall portions 106a-b will be substantially parallel to and located on opposite sides of the first plane of symmetry. Correspondingly, the third and fourth sidewall portions 106a-b will be substantially parallel to and located on opposite sides of the second plane of symmetry. As a result, the wall structure 106 preserves the first and second symmetry planes of the luminous intensity distribution of the physical source surface 102a.

In an ideal case (e.g. a truly Lambertian source surface 102a, the sidewall portions 106a-b and 106c-d being perfectly parallel to the respective planes of symmetry and presenting zero absorption) the transflective wall structure 106 would theoretically produce a virtual source image at every position on the wall structure 106, from every relevant viewing direction. In that case, the entire source surface 102a plus the surface of the transflective wall structure 106 would be perceived as the glare source. Hence, the glare source (i.e. the source area 102a) would no longer be seen as a flat rectangular source with sides A and B (wherein it is assumed that the wall structure 106 is arranged with zero separation from the periphery 102b of the source surface 102a) when viewed through the wall structure 106, but a block-shaped volume source with sides A and B mm and height H.

Assume, as an illustrative and non-limiting example, a square Lambertian source surface 102a having A=B=100 mm and a luminous flux of 1000 lm. This is a very bright and glary light source with a UGR (Unified Glare Rating) of 30 (according to the UGR tabular method, in the standard space with standard dimensions, surface reflectivity, luminaire spacing, and observer positions defined by Commission internationale de l'éclairage (CEN)). Luminaires with such a high UGR value are generally considered to be very uncomfortable, and even close to causing intolerable glare. Choosing the angle β=45°, corresponding to a height H=142 mm, and a reflectance of 50% results in an UGR value of 24 in an ideal case. This can still be glary in some situations (e.g., office lighting) but is sufficiently comfortable for circulation areas, corridors, or industrial activities. This improvement of 6 UGR points (2 UGR classes) is a notable improvement in glare performance. In practice, the virtual source image pattern will however typically not create a uniform luminous pattern illuminating the entire surface of the wall structure 106 from all relevant viewing directions. Therefore, the glare performance improvement will in practice generally be smaller than in the ideal case.

An improved estimate of glare performance for realistic luminance patterns may be obtained using ray-tracing software and by evaluating the glare performance with a generic glare model that does not make assumptions about the luminous source area (unlike UGR). In the below the Glare Sensation Score (GSS) is calculated for a wide range of viewing angles α and transflective wall reflectance values. It is to be noted that the GSS method considers only a single observer and a single glare source, unlike the UGR tabular method that evaluates the glare of a grid of luminaires in the ceiling of an indoor space. These GSS results are therefore not directly comparable to UGR values, because they may be different for other viewing distances or angles.

Calculation of the GSS needs several input parameters as described by Vissenberg et al. (A generic, visual system-based model for discomfort from glare. Lighting Research & Technology. July 2022. doi: 10.1177/14771535221112675). The main parameters for the calculation are:
A high-resolution luminance image from the source and transflective wall structure.
The vertical viewing angle α and the viewing distance d defining the distance between the viewer and the light source.
The adaptation or background illuminance.
The eye illuminance as determined by the intensity of the source (taking the transflective wall structure into account) and incident angle on the eye.

The following discussion may be better understood in conjunction with FIG. 2, showing a schematic side view of the lighting device 100 and definitions of a and d. It is to be noted that due to the view chosen in FIG. 2, the angle β shown in FIG. 2 corresponds to the projection of β onto the viewing plane, and that the proper definition of β is shown in FIG. 1. In the figure, the lighting device 100 is by way of example shown with the optical axis L and the light exit window 104 oriented in a top-down direction, representative for instance of a downlight luminaire. This is however merely an example and other orientations and use cases are equally possible.

The GSS is determined for two viewing conditions: foveal and peripheral.

Foveal viewing (scenario “F” in FIG. 2) means that the viewer looks right into the light source, which is obviously the worst-case viewing condition for direct glare. Peripheral viewing (scenario “P” in FIG. 2) means that the viewer looks to the horizon or “straight ahead” (which incidentally is the viewing direction assumed in UGR calculations).

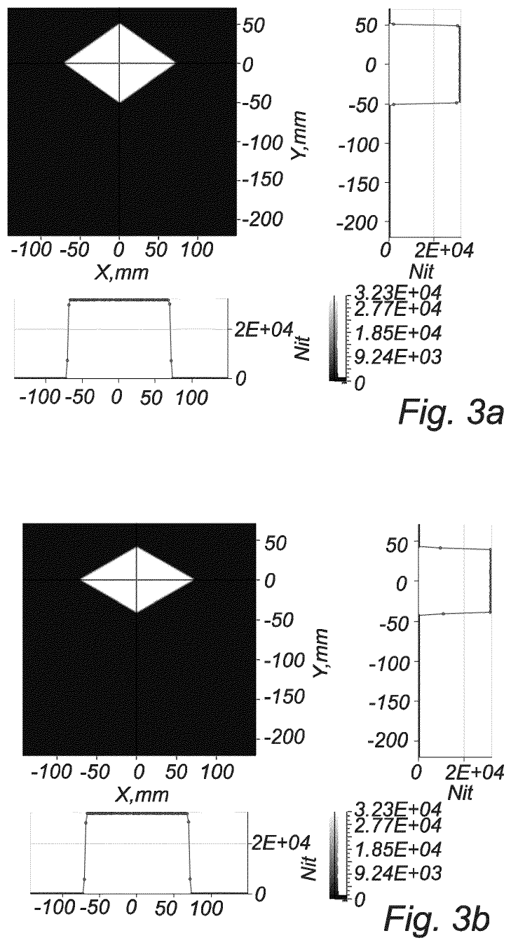

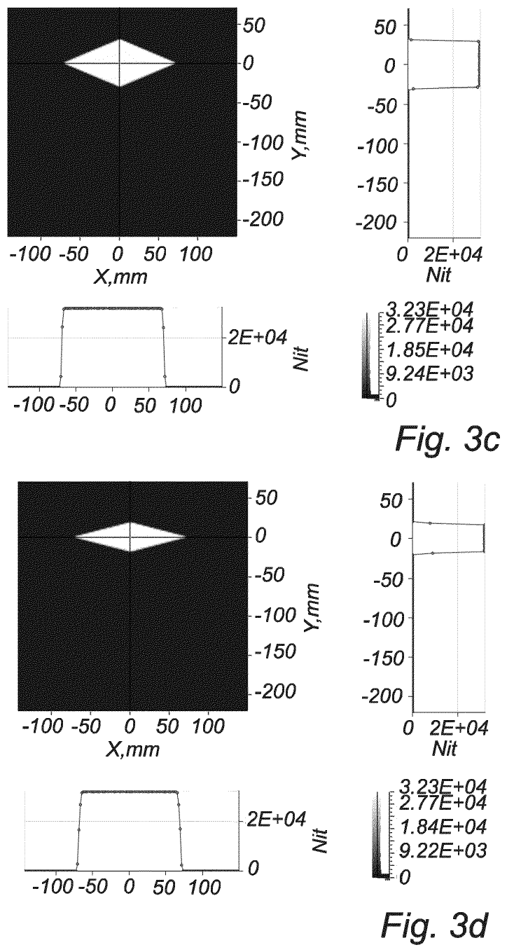

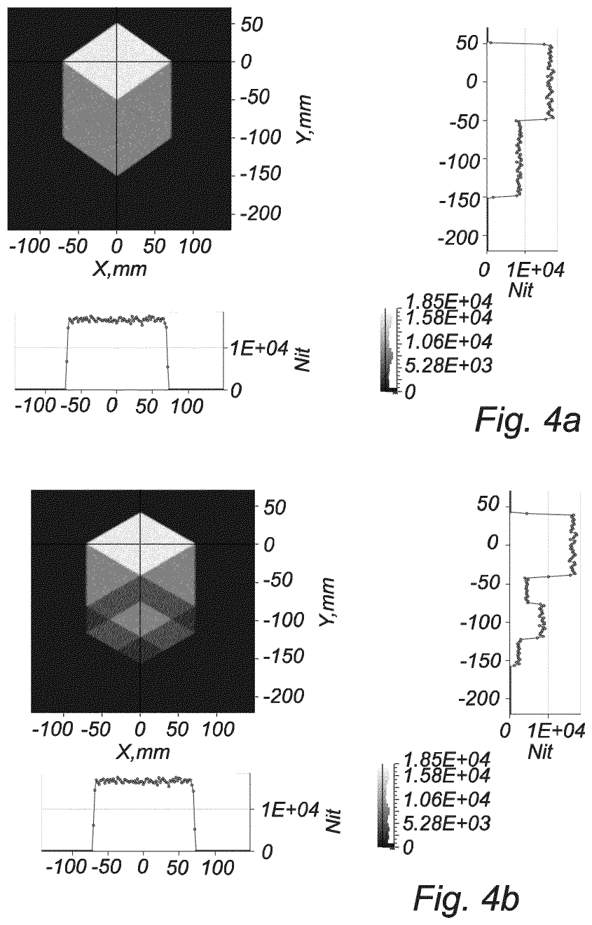

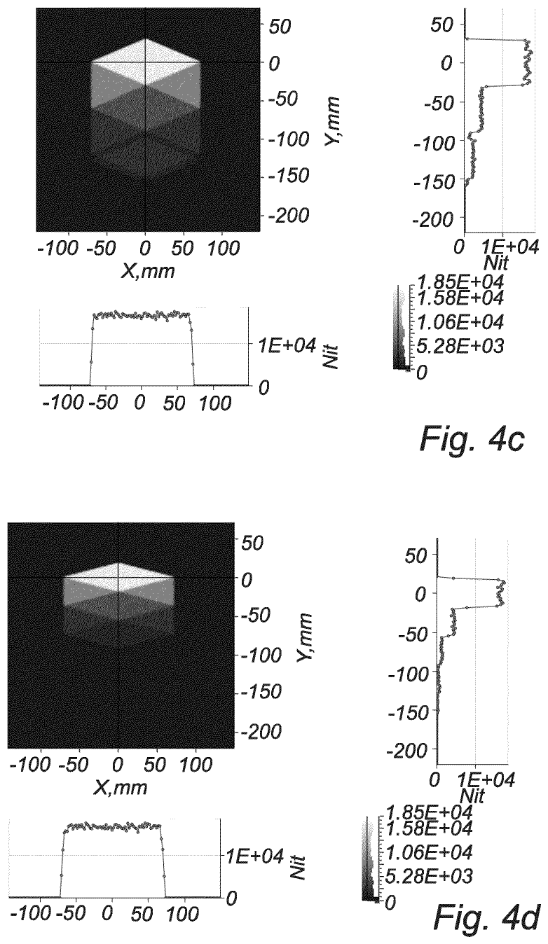

FIGS. 3a-d and 4a-d show luminance images of the bare source surface 102a (i.e. without the transflective wall structure 106) and of the source surface 102a viewed through the transflective wall structure 106 for viewing angles α=45° (FIGS. 3a and 4a), α=55° (FIGS. 3b and 4b), α=65° (FIGS. 3c and 4c) and α=75° (FIGS. 3d and 4d), calculated in optical ray tracing software (LightTools 9.1 from Synopsis). The source surface 102a is in each case a square Lambertian surface having A=B=100 mm and a luminous flux of 1000 lm. The graphs to the right and underneath the luminance image in each of FIGS. 3a-d and 4a-d show the luminance along Y=0 and X=0 in the luminance image, respectively. A reflectance of 50% is assumed for the wall structure 106.

The eye illuminance from the source for both foveal view (E_{foveal}) and peripheral view (Eₚₑᵣᵢₚₕₑᵣₐₗ) was calculated using equations (1)-(4):

$${I}_{0} = \frac{Flux}{π} \qquad ( Eq . 1 )$$

$${I}_{α} = \frac{Flux}{π} cos α \qquad ( Eq . 2 )$$

$${E}_{foveal} = \frac{{I}_{α}}{{d}^{2}} \qquad ( Eq . 3 )$$

$${E}_{peripheral} = \frac{{I}_{α}}{{d}^{2}} cos ( 90 - α ) \qquad ( Eq . 4 )$$

where Flux is the luminous flux [lm], l_{α} is the luminous intensity [cd] for viewing/emission angle α, and d=2 [m]. The eye illuminance also includes light from the background of the room (150 lux). The results of the calculated eye illuminance values [lm/m²] are presented in Table I.

TABLE I

| Viewing angle | Eye illuminance [lux] | Eye illuminance [lux] |
|---|---|---|
| α [deg] | (foveal view) | (peripheral view) |
| 45 | 56.25 | 39.75 |
| 55 | 45.63 | 37.38 |
| 65 | 33.63 | 30.50 |
| 75 | 20.63 | 19.94 |

From the luminance images in FIG. 4a-d, it may be seen that the surfaces of the wall structure 106 are not evenly lighting up and under some viewing angles parts of the transflective walls remain relatively dark, which may lead to less glare suppression. By comparing the luminance images in FIG. 3a-d to the luminance images in FIG. 4a-d it may further be observed that the wall structure 106 decreases the peak luminance and increases the luminous area of the source. The peak luminance is independent of the viewing angle.

Table II and III shows the GSS value calculated for all images in FIGS. 3a-d and 4a-d, assuming an adaption luminance of 150 lux.

TABLE II

| | GSS | GSS | |
|---|---|---|---|
| | (foveal) | (foveal) | |
| | with wall | NO wall | ΔGSS = GSS(with wall structure) − |
| α | structure | structure | GSS (NO wall structure) |
| 45 | 2.34 | 2.44 | −0.10 |
| 55 | 2.20 | 2.32 | −0.12 |
| 65 | 2.01 | 2.16 | −0.15 |
| 75 | 1.79 | 1.94 | −0.15 |

TABLE III

| | GSS | GSS | |
|---|---|---|---|
| | (peripheral) | (peripheral) | |
| | with wall | NO wall | ΔGSS = GSS(with wall structure) − |
| α | structure | structure | GSS (NO wall structure) |
| 45 | 1.15 | 1.26 | −0.11 |
| 55 | 1.22 | 1.40 | −0.18 |
| 65 | 1.42 | 1.67 | −0.25 |
| 75 | 1.52 | 1.81 | −0.29 |

Tables II and III show that the transflective wall structure 106 gives a decrease in GSS value for both viewing conditions (foveal and peripheral). The decrease in GSS value is largest for peripheral viewing.

From Vissenberg et al., it may be deduced that the glare reduction in foveal view (about 0.13 GSS) is comparable to roughly 1.5 UGR points, and the glare reduction in peripheral view (about 0.21 GSS) is comparable to about 2.5 UGR points, i.e., almost one UGR class. This is less than the 6 UGR points improvement of the ideal estimate above, which may partly be due to the specific observer-source distance (the glare reduction may be stronger at other distances) and partly due to the non-uniform luminance patterns. In peripheral view, people are much less sensitive to the luminance pattern, which explains why the glare reduction works better for peripheral view than for foveal view.

FIGS. 5a-b provide an illustrative comparison between a luminaire comprising a lighting device without a transflective wall structure (FIG. 5a) and a luminaire comprising a lighting device provided with a transflective wall structure, according to an exemplifying embodiment (FIG. 5b). The luminaires are by way of example shown in the form of ceiling-mounted downlights. The upper part of FIG. 5a shows a ray trace image of the un-shielded light source 202 of the luminaire, e.g. corresponding to a conventional arrangement of a downlight. The light source 202 comprises in this example a circular source area (or surface) 202a. The lower part of FIG. 5a is a schematic depiction of a cross section taken along a diameter of the source area 202a, and an eye in foveal viewing of the source area 202a.

The upper and lower parts of FIG. 5b show corresponding views when the lighting device 200 of the luminaire is provided with a transflective wall structure 206, more specifically a circular cylindrical wall structure surrounding the circular source area 202a, and being parallel to and symmetric about the optical axis L. As illustrated in the cross-sectional view in the lower part of FIG. 5b, taken through mutually opposite (curved) sidewall portions 206a-b of the wall structure 206, the specular reflectivity and non-scattering transmission of the walls structure 106 results in a virtual image 202b of the physical source area 202a. As further shown, a portion 202ab of the physical source area 202a is viewed through the sidewall portion 206a such that only a portion 202aa of the source area 202a is directly viewed by the observer. Hence, the combined source image as seen by the viewer is formed by the union of 202aa, 202ab and 202b, providing a reduced glare compared to the bare view of the source area 202a in FIG. 5a.

The person skilled in the art realizes that the present invention by no means is limited to the preferred embodiments described above. On the contrary, many modifications and variations are possible within the scope of the appended claims. For example, in the illustrated example of FIG. 1, the first, second, third and fourth flat sidewall portions 106a-d extend along the entire length of the periphery 102b of the source surface 102a. In other words, the wall structure 106 completely surrounds the source area 102a and the optical axis L in the circumferential direction. While this may be advantageous in that glare reduction may be provided for any azimuthal viewing angle ø, a complete circumferential extension is not a requirement in all applications. For instance, in some lighting applications, it may be sufficient to reduce glare from two opposite sides of the source area 102a, such as for a light source providing a luminous intensity distribution with only a single plane of symmetry (one example being road lighting). With reference to FIG. 1, a modified wall structure for such an application may be formed by e.g. only the first and second sidewall portions 106a-b, parallel to and on opposite sides of the single plane of symmetry, and having open sides instead of the third and fourth sidewall portions 106c-d. Additionally, in case of light source emitting light in a luminous intensity distribution being radially symmetric with respect to the optical axis L as in FIG. 5b, a rectangular or square box-shaped wall structure centered on the optical axis L may be used instead of the circular cylindrical wall structure 206. More generally, the wall structure may comprise a number n of sidewall portions arranged in a shape of an n-sided polygon centered on the optical axis (L), wherein n is an even number equal to or greater than 4. The case of n=4 corresponds to the aforementioned rectangular or square-shaped arrangement of the sidewall portions 106a-d. A greater number of sidewall portions (e.g. n=6 corresponding to a hexagon, n=8 corresponding to an octagon, n=10 corresponding to a decagon, etc.) is however also possible. A polygon with an even number n of sides (e.g. 4, 6, 8, 10, . . . ) enables a wall structure to be arranged such that each of the n sidewall portions has a corresponding parallel sidewall portion on a directly opposite side of the optical axis L. The polygon may e.g. be a regular n-sided polygon (such as a square, a regular hexagon, a regular octagon, etc.). According to a further example, the height H of the wall structure 106 may vary along the circumferential direction (which corresponds to the azimuthal viewing angle φ). For example, if A>B (implying an elongated rectangular shaped source area 102a in FIG. 1) the first and second sidewall portions 106a-b may have a greater height H than the third and fourth sidewall portions 106c-d to screen the source area 102a such that the vertical minimum or threshold viewing angle α (i.e. αₜₕ) above which the source area 102a is completely screened by the wall structure 106 is the same when viewing the source area 102a through the first or second sidewall portions 106a-b and the third or fourth sidewall portions 106c-d. The height may also be varied continuously along the circumferential direction to obtain a minimum vertical viewing angle α (αₜₕ) above which the source area 102a is completely screened by the wall structure which varies in dependence on the azimuthal viewing angle φ or is constant (e.g. a rectangular wall structure with an increased height at the corners). Moreover, while in the above, an example embodiment of the lighting device 100 has been disclosed with reference to a flat light emitting area or surface 102a, it is noted that the concept also is applicable to non-planar geometries, such as light sources comprising a curved (e.g. rounded or bulb-shaped) source surface.

1. A lighting device comprising:
a light source comprising one or more light emitting devices, LEDs, and a diffusive, light emitting area, the light source being configured to transmit light through the light emitting area towards a light exit window of the lighting device, along an optical axis, the light emitting area having a periphery; and
a transflective wall structure for reducing a glare of the light emitting area when viewed through the wall structure, the wall structure surrounding the light emitting area and extending between the light emitting area and the light exit window in a direction substantially parallel to the optical axis,
wherein the light emitted from the light emitting area comprises a direct portion propagating directly between the light emitting area and the light exit window, and a divergent portion incident on an inwardly facing surface of the wall structure, and
wherein the transflective wall structure is transparent and specularly reflective such that the divergent portion of the light is in part transmitted through the wall structure, and in part guided towards the light exit window by being specularly reflected by the wall structure,
wherein the wall structure comprises first and second sidewall portions arranged on opposite sides of, and at a same distance from, the optical axis,
wherein the light source is configured to emit the light in a luminous intensity distribution having at least a first plane of symmetry, and wherein th first and second sidewall portions are flat sidewall portions substantially parallel to the first plane of symmetry and arranged on opposite sides of, and at a same distance from, the first place of symmetry, and
wherein the wall structure comprises third and fourth sidewall portions connecting the first and second sidewall portions and arranged on opposite sides of the optical axis.

2. The lighting device according to claim 1, wherein the wall structure has a specular reflectance in a range from 14% to 86%, preferably 20% to 80%, or even more preferably 40% to 60%, for the light emitted by the light source.

3. (canceled)

4. (canceled)

5. (canceled)

6. The lighting device according to claim 1, wherein the luminous intensity distribution further has at least one second plane of symmetry transverse to the first plane of symmetry, and wherein the third and fourth sidewall portions are flat sidewall portions being substantially parallel to the second plane of symmetry and arranged on opposite sides of, and at a same distance from, the second plane of symmetry.

7. The lighting device according to claim 1, wherein the light source is configured to emit the light in a luminous intensity distribution being radially symmetric with respect to the optical axis, and wherein the wall structure is radially symmetric with respect to the optical axis, or wherein the wall structure comprises n sidewall portions arranged in a shape of an n-sided polygon centered on the optical axis, wherein n is an even number equal to or greater than 4.

8. The lighting device according to claim 1, wherein the wall structure extends along at least a part of the periphery of the light emitting area.

9. The lighting device according to claim 8, wherein the wall structure extends along a full length of the periphery of the light emitting area.

10. The lighting device according to claim 1, wherein the light emitting area is a flat light emitting surface extending in a plane transverse to the optical axis and the wall structure, said wall structure is arranged with essentially zero separation from the periphery of the light emitting area.

11. The lighting device according to claim 10, wherein the light emitting surface is a Lambertian emitter.

12. The lighting device according to claim 1, wherein a height of the wall structure, with respect to the light emitting area, is such that the light emitting area is shielded by the wall structure when viewed from a viewing angle relative the optical axis exceeding a threshold angle, wherein the threshold angle is in a range from 40-70°.

13. The lighting device according to claim 1, wherein a height of the wall structure, with respect to the light emitting area, varies along a circumferential direction with respect to the optical axis.

14. The lighting device according to claim 1, wherein the wall structure has a specular reflectance which varies along the optical axis.

15. The lighting device according to claim 1, wherein, in operation, the diffusive, light emitting area has a luminance of at least 1000 cd/m² at an angle α>=65 degrees with a normal to the diffusive, light emitting area.
